(19) United States
(12) Patent Application Publication
(10) Pub. No.: US 2023/0413789 A1
(43) Pub. Date: Dec. 28, 2023

(54) SYSTEM AND METHOD FOR REMOVAL AND PROCESSING OF AQUACULTURE MORTALITIES

(71) Applicant: Forever Oceans Corporation, Bethesda, MD (US)

(72) Inventors: Anthony White, Kailua-Kona, HI (US); Mathew Goldsborough, Kamuela, HI (US); Nicholas Sturla, Kailua-Kona, HI (US); Robert Piispanen, Kailua-Kona, HI (US)

(21) Appl. No.: 18/215,472

(22) Filed: Jun. 28, 2023

Related U.S. Application Data
(63) Continuation of application No. PCT/US2021/065477, filed on Dec. 29, 2021.
(60) Provisional application No. 63/131,982, filed on Dec. 30, 2020.

(51) Int. Cl. A01K 61/13; B63G 8/00; B63G 8/08

(52) U.S. Cl. CPC A01K 61/13; B63G 8/001; B63G 8/08; B63G 2008/004

(57) ABSTRACT

Provided is a system for automatically removing mortalities, such as deceased fish or other animals, from an aquaculture cage. An underwater robotic vehicle can traverse an aquaculture cage to collect the mortalities. The collected mortalities can be delivered by the vehicle to a dock, where the mortalities can be offloaded from the vehicle and stored in the dock. The mortalities can be pumped to a surface vessel where the mortalities can be dewatered, photographed, and/or weighed, before being stored for further processing.

### CROSS-REFERENCE TO RELATED APPLICATIONS

This application is a continuation of International Application No. PCT/US21/053749 filed Oct. 6, 2021, which claims the benefit of U.S. Provisional Patent Application No. 63/131,982, filed Dec. 30, 2020, the disclosures of which are incorporated by reference herein in their entireties.

### TECHNICAL FIELD

In various examples, this disclosure relates to the use of robotics, aquaculture, and automation and, more particularly, to the use of robotics, aquaculture, and automation for removing and processing mortalities in an aquaculture environment.

### BACKGROUND

Removing deceased fish, known as mortalities, from an aquaculture cage is of paramount importance. Mortalities occur during almost any aquaculture growing cycle and, when left in the cage, can start to decay, playing host to parasites and disease. Failure to remove mortalities can lead to contamination of the cohort, and one dead fish can become many dead fish, reducing the profitability of the farm.

Traditional methods for removing mortalities from an aquaculture cage fall into two categories: manual and mechanically assisted. Manual removal of mortalities requires divers to enter the aquaculture cage and physically remove mortalities from the cage floor or walls by hand. This is not only expensive and time consuming, but dangerous. Entering a stocked aquaculture cage is a strenuous task, requiring divers to spend copious amounts of time tens of meters below the surface performing physically demanding work while in the presence of a densely packed school of fish, with limited visibility. Mechanically assisted mortality removal methods usually involve a pump being lowered into a cage at a strategic location and pumping the mortalities to the surface. This process incurs its own difficulties. If the cage in question is submerged, the cage must be raised for mortality removal. The mechanically assisted method can require equipment and personnel to be onsite to operate, such that mortality removal may not be an option during inclement weather, in an effort to ensure the safety of equipment and personnel. The interruption in cleaning cycles can lead to mortalities being left too long in the cage which can lead to the aforementioned negative effects.

There is therefore a pressing need to perform mortality removal in an automated, timely, and dexterous manner.

The foregoing discussion, including the description of motivations for some embodiments of the invention, is intended to assist the reader in understanding the present disclosure, is not admitted to be prior art, and does not in any way limit the scope of any of the claims.

### SUMMARY

In general, the apparatus, methods, and systems described herein relate to automatic removal of dead fish or other mortalities from an aquaculture cage. An example system includes an automated and/or remotely controlled underwater vehicle that can access all areas and interior surfaces of the aquaculture cage. The vehicle is configured to identify mortalities in the aquaculture cage, collect the mortalities, and deliver the mortalities to a dock attached to the aquaculture cage. The mortalities can be pumped from the dock to a surface support barge for further processing.

In one aspect, the subject matter of this disclosure relates to a system for removing mortalities from an aquaculture cage. The system includes: an underwater vehicle including: a plurality of thrusters configured to orient and propel the vehicle in an aquaculture cage submerged in a body of water; a capture enclosure configured to carry a plurality of mortalities collected by the vehicle in the aquaculture cage; and a suction device configured to provide suction for transferring the mortalities into the capture enclosure; and a dock attached to the aquaculture cage and including: a closeable gate defining a passageway to receive the mortalities from the vehicle; and a storage tank for storing the mortalities received from the vehicle.

In certain examples, the vehicle can be configured to perform mortality removal tasks autonomously, and the tasks can include identifying the mortalities in the aquaculture cage, collecting the mortalities from the aquaculture cage, and transferring the mortalities to the storage tank. The vehicle can be configured to be controlled by an operator using remote control. The thrusters can be configured to move the vehicle to any location within the aquaculture cage. The capture enclosure can be disposed on a bottom portion of the vehicle, and the capture enclosure can include: an open end for receiving the mortalities; and an opposite end containing the suction device. The gate can be slidable within the dock from a closed position to an open position. The gate can include a buoyancy element that causes the gate to be in the closed position when the vehicle is not attached to the dock.

In some instances, the vehicle can be configured to attach to the dock and slide the gate to the open position. The vehicle can be configured to attach to the dock by connecting a hook on the vehicle to a linkage on the dock.

In certain examples, the system can further include: a vessel floating on the body of water; and a conduit for conveying the mortalities from the storage tank to the vessel. The system can include a pumping device for conveying the mortalities from the storage tank to the vessel. The vessel can include: a dewatering table for receiving the mortalities from the storage tank; one or more sensors for measuring weights or quantities of mortalities; and a processing system for storing or processing mortalities received from the dewatering table.

In another aspect, the subject matter of this disclosure relates to a method of removing mortalities from an aquaculture cage. The method includes: using an underwater vehicle to collect mortalities from an aquaculture cage submerged in a body of water, wherein the vehicle includes: a plurality of thrusters configured to orient and propel the vehicle in the aquaculture cage; a capture enclosure configured to carry the collected mortalities; and a suction device configured to provide suction for transferring the mortalities into the capture enclosure; attaching the vehicle to a dock attached to the aquaculture cage, wherein the dock includes a closeable gate and a storage tank; and transferring the mortalities from the vehicle, through a passageway defined by the gate, and into the storage tank.

In various implementations, using the vehicle to collect mortalities can include identifying the mortalities in the aquaculture cage. The vehicle can be configured to identify and collect the mortalities autonomously. Attaching the vehicle to the dock can include connecting a hook on the vehicle to a linkage on the dock. Transferring the mortalities from the vehicle can include opening the gate. Transferring the mortalities from the vehicle can further include: closing the gate; and detaching the vehicle from the dock. The method can include pumping the mortalities from the storage tank to a vessel floating on the body of water. The method can include: dewatering the mortalities pumped to the vessel; measuring weights or quantities of the dewatered mortalities; and storing or processing the dewatered mortalities on the vessel.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a front perspective view of a mortality removing robotic vehicle, according to one embodiment;

FIG. 1B is a left side view of the vehicle of FIG. 1A, according to one embodiment;

FIG. 1C is a front view of the vehicle of FIG. 1A, according to one embodiment;

FIG. 1D is a right side view of the vehicle of FIG. 1A, according to one embodiment;

FIG. 1E is a rear view of the vehicle of FIG. 1A, according to one embodiment;

FIG. 1F is a bottom view of the vehicle of FIG. 1A, according to one embodiment;

FIG. 1G is a top view of the vehicle of FIG. 1A, according to one embodiment;

FIG. 2A is a front perspective view of a dock in a closed configuration, according to one embodiment;

FIG. 2B is a right side view of the dock of FIG. 2A, according to one embodiment;

FIG. 2C is a front view of the dock of FIG. 2A, according to one embodiment;

FIG. 2D is a rear view of the dock of FIG. 2A, according to one embodiment;

FIG. 2E is a bottom view of the dock of FIG. 2A, according to one embodiment;

FIG. 2F is a top view of the dock of FIG. 2A, according to one embodiment;

FIG. 2G is a front perspective view of the dock of FIG. 2A in an open configuration, according to one embodiment;

FIG. 2H is a front view of the dock of FIG. 2G, according to one embodiment;

FIG. 3A is a rear perspective view of the vehicle of FIG. 1A attached to the dock of FIG. 2G, according to one embodiment;

FIG. 3B is a top view of the vehicle of FIG. 1A attached to the dock of FIG. 2G, according to one embodiment;

FIG. 4 is a schematic diagram of an aquaculture cage in which the dock of FIG. 2G is attached to a sidewall of the aquaculture cage, and the vehicle of FIG. 1A is attached to the dock, according to one embodiment;

FIG. 5 is a schematic diagram of a mortality removal system for an aquaculture cage, according to one embodiment; and

FIG. 6 is a flowchart of a method of removing mortalities from an aquaculture cage, according to one embodiment.

The invention will be readily described and illustrated in the figures herein, and may be arranged and designed in a wide variety of different configurations. Thus, the following detailed description of the embodiments of an automated mortality removal system and method, as represented in the attached figures, is not intended to limit the scope of the invention, but is merely representative of selected embodiments of the invention which have been developed and tested successfully.

### DETAILED DESCRIPTION

The features, structures, or characteristics of the invention described throughout this specification may be combined in any suitable manner in one or more embodiments. For example, usage of the phrases “certain embodiments,” “some embodiments,” “certain examples,” or other similar language, throughout this specification can indicate that a particular feature, structure, or characteristic described in connection with the embodiment may be included in at least one embodiment of the present invention. Thus, appearances of the phrases “in certain embodiments,” “in some embodiments,” “in other embodiments,” “in certain examples,” “in some implementations,” or other similar language, throughout this specification do not necessarily all refer to the same group of embodiments, and the described features, structures, or characteristics may be combined in any suitable manner in one or more embodiments.

Additionally, if desired, the different configurations and functions discussed below may be performed in a different order and/or concurrently with each other. Furthermore, if desired, one or more of the described configurations or functions may be optional or may be combined. As such, the following description should be considered as merely illustrative of the principles, and embodiments of this invention, and not in limitation thereof.

In various examples, an autonomous robotic vehicle can operate inside an aquaculture cage to collect mortalities (e.g., dead fish), remove the mortalities from the cage environment, and deposit the mortalities in a specified location. The vehicle can navigate the cage using a plurality of thrusters (e.g., 8 thrusters), which can each include a motor, a propeller, and/or a kort nozzle, arranged to provide 6 degrees of freedom for mobility and stability. The vehicle (alternatively referred to as a “rover”), can be equipped with internal and/or external sensors to aid in navigation as well as actuation, during mortality acquisition and locomotion. The vehicle can be accompanied by or paired with a base or home unit (alternatively referred to as a “dock”), which can receive deposits of dead fish or other mortalities collected by the vehicle. The vehicle can start and end a collection cycle at the dock.

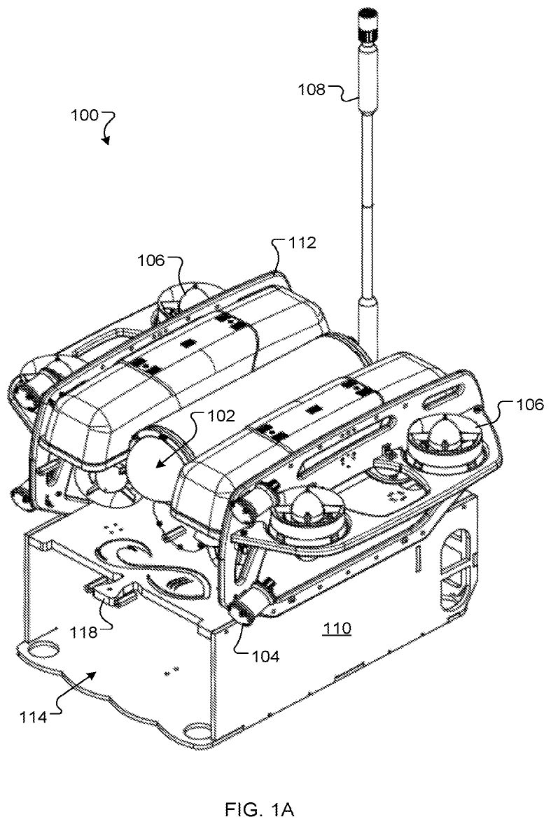

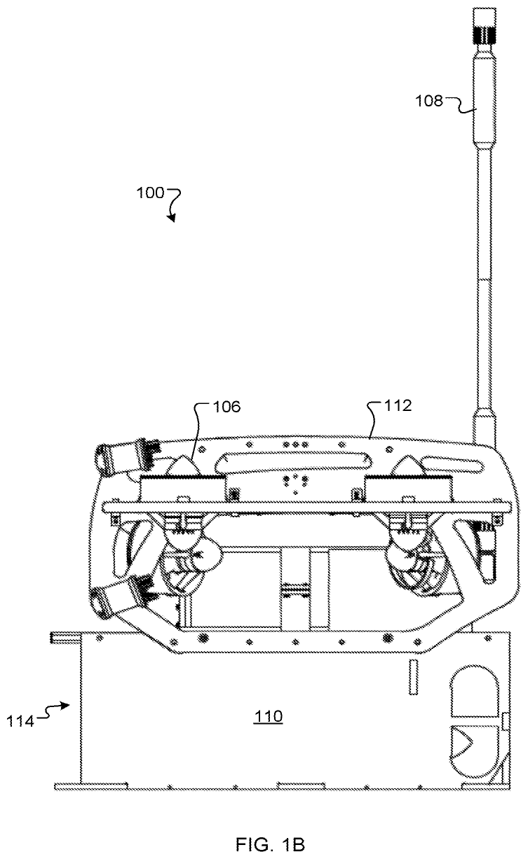

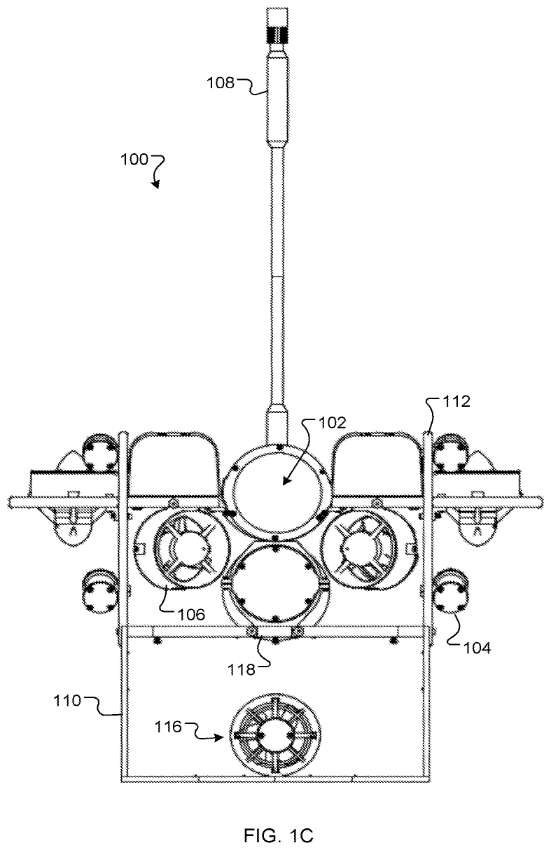

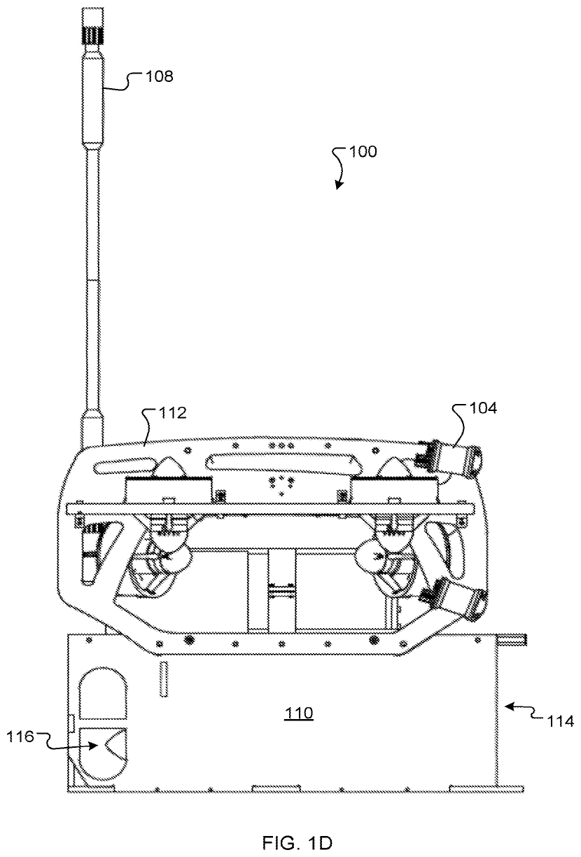

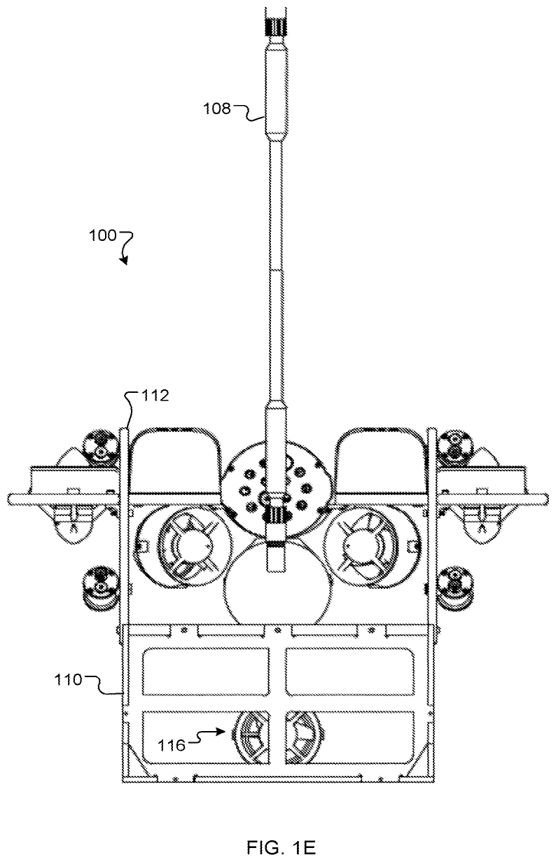

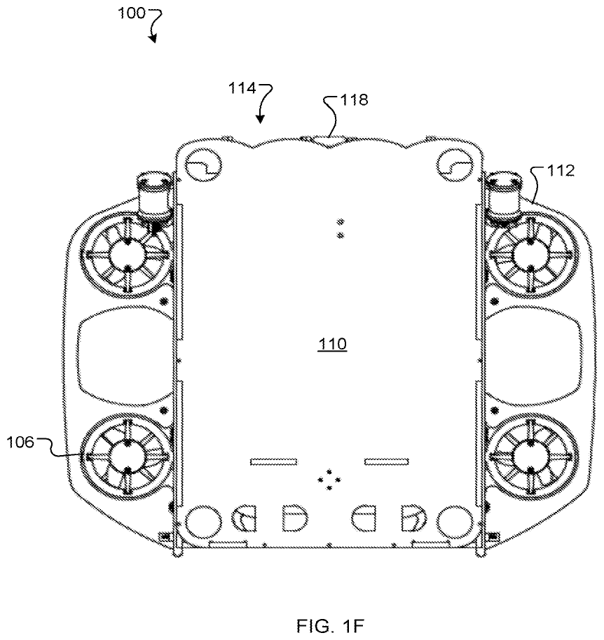

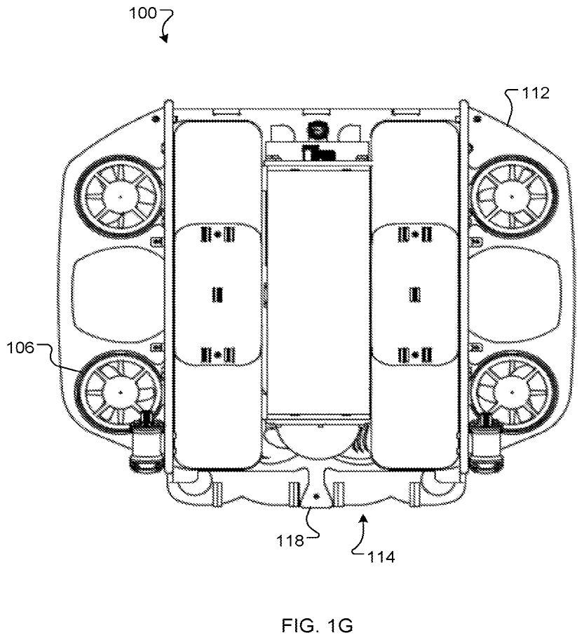

FIGS. 1A-1G include various views of one embodiment of a mortality collecting robotic vehicle or rover 100. The vehicle 100 can be operated automatically and/or via remote control and can travel underwater in all regions of an aquaculture cage. The vehicle can travel along netting or other surfaces of the aquaculture cage and can swim or fly in any direction relative to such surfaces. The vehicle 100 can include or utilize one or more sensors 102 (e.g., enclosed within a clear dome of acrylic or glass) and/or a processor for collecting and processing data to identify mortalities in the cage. The one or more sensors 102 can be or include, for example, a camera, a proximity sensor, a depth sensor, a scanning sonar sensor, a doppler-velocimetry position sensor, and/or machine vision. Images or other data captured by the sensors can be processed (e.g., using computer vision and/or machine learning models) to distinguish mortalities from other items in the cage (e.g., live fish). A processor for the vehicle 100 can be onboard the vehicle 100 and/or located on a surface barge or vessel or other remote location. The vehicle can include one or more lights 104 for operation in low light and/or to assist with vehicle navigation.

The depicted example of the vehicle 100 utilizes a plurality of thrusters 106 that enable the vehicle 100 to navigate the cage. Alternatively or additionally, the vehicle 100 can use friction elements (e.g., treads or toothed wheels) to travel along or climb on cage netting or other cage surfaces. The thrusters 106 and/or friction elements can allow the vehicle 100 to navigate or access all cage netting surfaces and other regions within the cage, such that the vehicle 100 is not confined to a bottom or floor portion of the cage. For conciseness, “cage floor” as used herein can refer to any portion of a cage boundary (e.g., a mesh surface, cage walls, etc.) that the vehicle 100 may contact or access.

The vehicle 100 can include a tether 108 for receiving power and/or providing communications to and/or from other system components, which may be located on a surface support barge platform or other surface vessel (not shown). In some instances, for example, the tether 108 can enable an operator of the vehicle 100 to control the vehicle from a remote location, such as from the surface support barge platform or from an onshore location many kilometers away (e.g., more than 10, 100, or 1000 kilometers).

In various implementations, a body of the vehicle 100 may include two separate sections: a capture enclosure 110 and a vehicle frame 112. In the depicted embodiment, the capture enclosure 110 is located on an underside of the vehicle 100 and may be sized to accommodate any number of mortalities that may be anticipated or encountered during a cleaning cycle. The function of the capture enclosure 110 is to collect or carry the mortalities. The mortalities can enter the capture enclosure 110 through an opening 114 (e.g., an open face) on one side. The capture enclosure 110 can have a suction thruster 116 or other device (e.g., on a side opposite the opening 114, as shown in FIG. 1D) to provide suction for drawing mortalities into the capture enclosure 110. The suction thruster 116 can create a pressure differential near the capture enclosure 110, so that mortalities can be captured and/or ejected. For example, the suction thruster 116 can pull water through the opening 114 and into the capture enclosure 110 when mortalities are being collected and can push water through the opening 114 and out of the capture enclosure 110 when mortalities are being ejected into the dock, as described herein. The suction thruster 116 and the thrusters 106 can each be the same component or part. Referring to FIG. 1A, the vehicle can include a hook 118 (e.g., having dovetail profde) or other member for connecting to the dock. The vehicle frame 112, the capture enclosure 111, and/or other portions of the vehicle 100 may be constructed out of or include one or more polymeric materials (e.g., High Density Polyethylene (HDPE), polypropylene, polyester, or nylon), metals (e.g., aluminum), and/or other appropriate materials.

In certain implementations, the navigation thrusters 106 on the vehicle 100 can be located on or near a top portion of the vehicle frame 112 and oriented so that a first portion (e.g., half) of the thrusters 106 produce vertical thrust and a second portion of the thrusters 106 produce lateral thrust. Automatic mixing of throttle levels of these thrusters can stabilize the vehicle 100 and/or provide acceleration or rotation in any direction, thereby aiding acquisition of mortalities in any location within the cage.

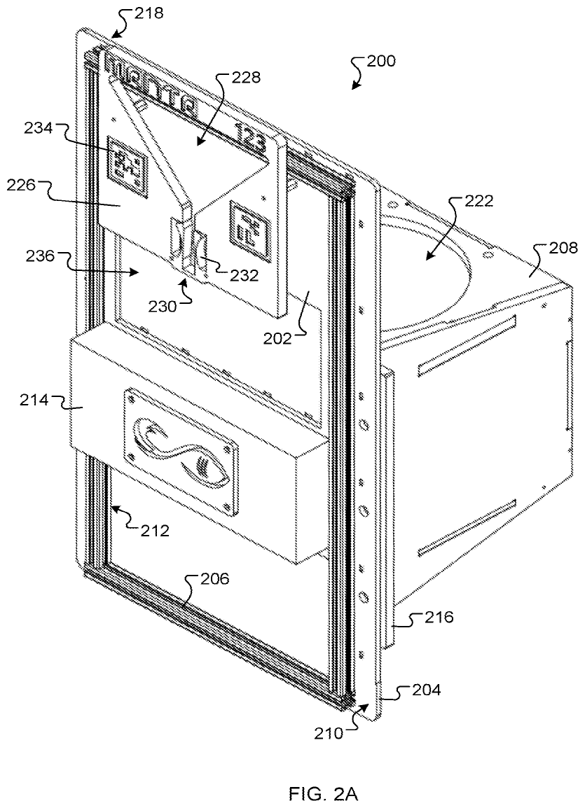

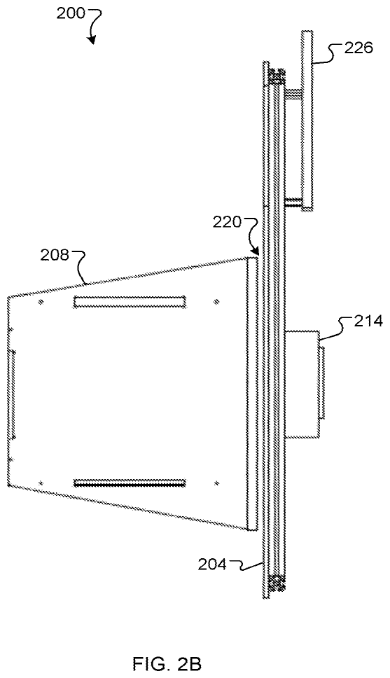

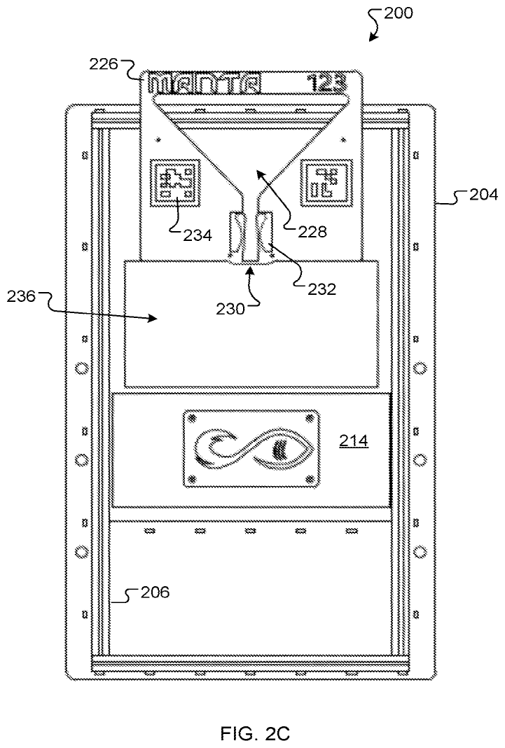

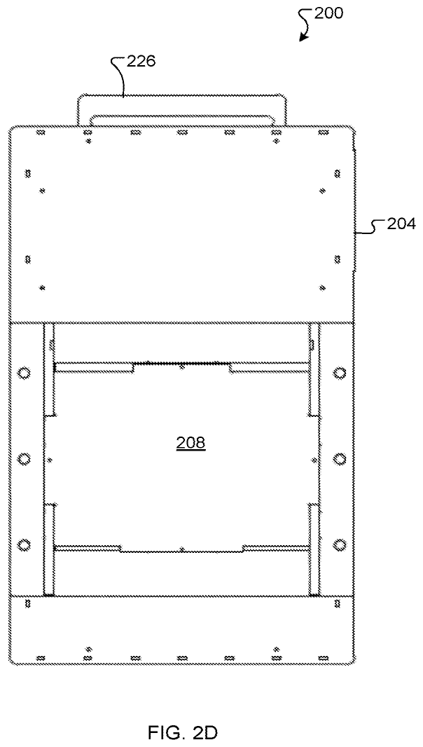

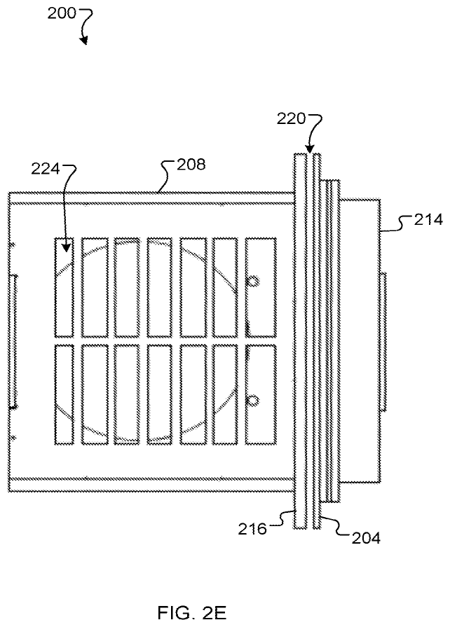

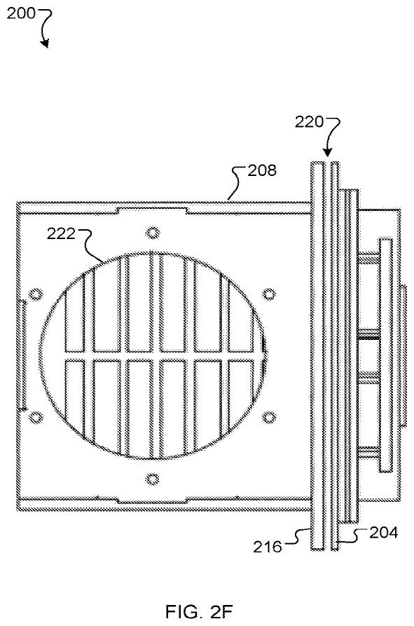

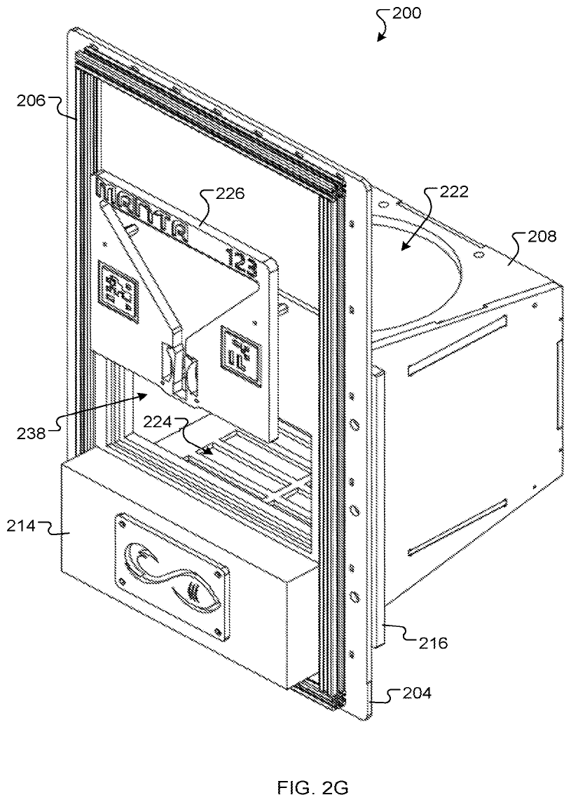

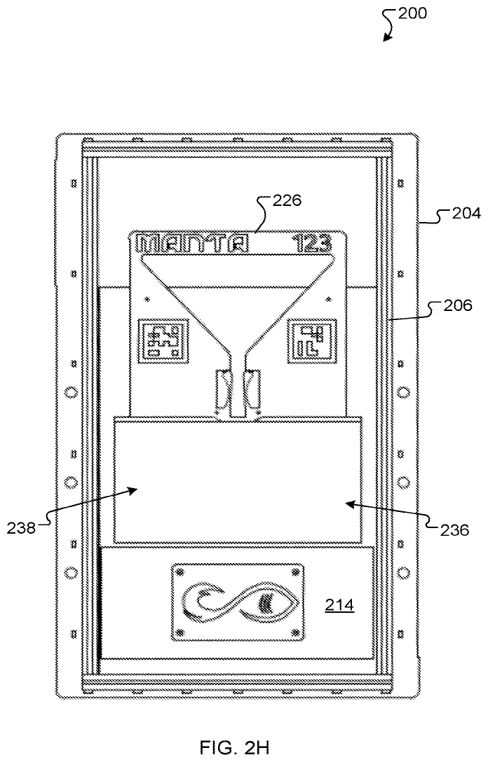

FIGS. 2A-2H include various views of a dock 200 that can be attached to an aquaculture cage (e.g., a sidewall of the cage) and can serve as a base or home unit for the mortality collecting vehicles described herein (e.g., vehicle 100). The dock 200 can include a gate 202, a back plate 204, a frame 206, and a storage tank 208. The gate 202 is positioned within the frame 206, which is attached to a front side 210 of the back plate 204. The frame 206 includes a groove 212 or slot on an inner edge or perimeter of the frame 206. Edges on opposites sides of the gate 202 are positioned within or confined by the groove 212, such that the gate 202 can slide up or down within the frame 206. FIGS. 2A-2C show the gate 202 at an uppermost or “closed” position within the frame 206, and FIGS. 2G and 2H show the gate 202 at a lowermost or “open” position within the frame 206. A buoyancy element 214 is attached to the gate 202 and keeps the gate 202 in the closed position, unless a downward force is applied (e.g., by the vehicle 100) to open the gate 202.

The storage tank 208 includes a flange 216 for securing the storage tank 208 to a back side 218 of the back plate 204. In one example, the storage tank 208 is located outside of the aquaculture cage and the back plate 204 and other portions of the dock 200 are located inside the aquaculture cage. For example, a netting or sidewall material for the aquaculture cage can be positioned in a gap region 220 between the flange 216 and the back plate 204 (e.g., as shown in FIG. 2B). A hole (not shown) can be cut in the netting to permit mortalities to be moved from the cage into the storage tank 208. A top surface of the storage tank 208 defines an opening 222 where a conduit or tube (not shown) can be attached. Mortalities can be pumped from the storage tank 208, through the conduit, and to a surface support barge platform or other surface vessel (not shown). A bottom surface of the storage tank 208 defines at least one opening 224 that permits passage of water into or out of the storage tank 208 but prevents passage of mortalities (e.g., as shown in FIG. 2E).

In various examples, a capture and retention plate 226 is attached to the gate 202 and used for securing a mortality collection vehicle (e.g., the vehicle 100) to the dock 200. The capture and retention plate 226 can define a funnel-shaped opening 228 and a dock linkage 230, which can include a retention latch 232. The capture and retention plate 226 can include one or more optical targets 234 that the vehicle can use to determine its position or orientation relative to the capture and retention plate 226. During a docking event, a hook (e.g., the hook 118) or other protruding member of the vehicle can be passed through the funnel-shaped opening 228 and brought down into the dock linkage 230, where the retention latch 232 can apply a holding force (e.g., using a spring or a frictional catch) to secure the hook and vehicle in place. The weight of the vehicle and/or a downward force applied by thrusters (e.g., the thrusters 106) on the vehicle can then cause the gate to slide downward within the frame 206 to the open position. Once opened, a window 236 in the gate 202 can be aligned with a window 238 in the storage tank 208 and/or back plate 204 (e.g., as shown in FIGS. 2G and 2H). With the windows 236 and 238 aligned, mortalities collected by the vehicle can be transferred from the vehicle (e.g., by reversing the suction thruster 116), through the windows 236 and 238, and into the storage tank 208. Once the mortalities have been transferred to the storage tank 208, the vehicle can close the gate 202 by applying an upward force with the thrusters on the vehicle. Additionally or alternatively, the upward force can cause the hook to be released by the retention latch 232. The hook can then be removed from the dock linkage 230 and funnel-shaped opening 228, such that the vehicle is no longer connected to the dock 200 and is free to collect additional mortalities from the aquaculture cage, as needed.

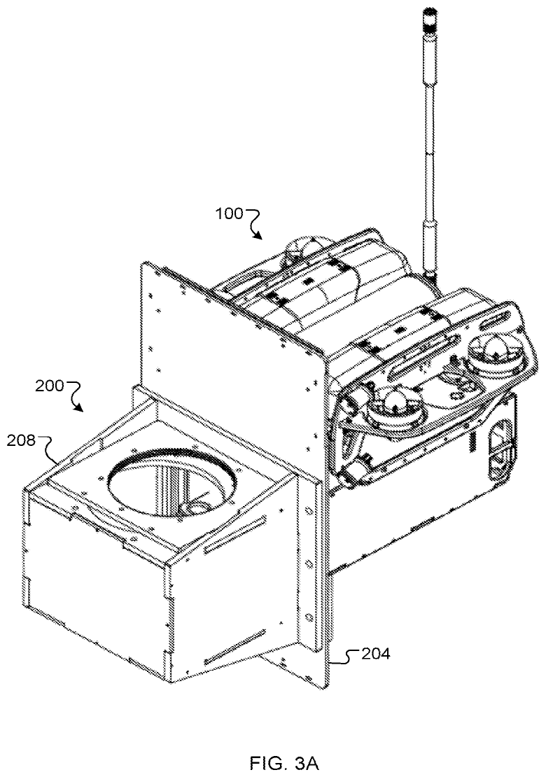

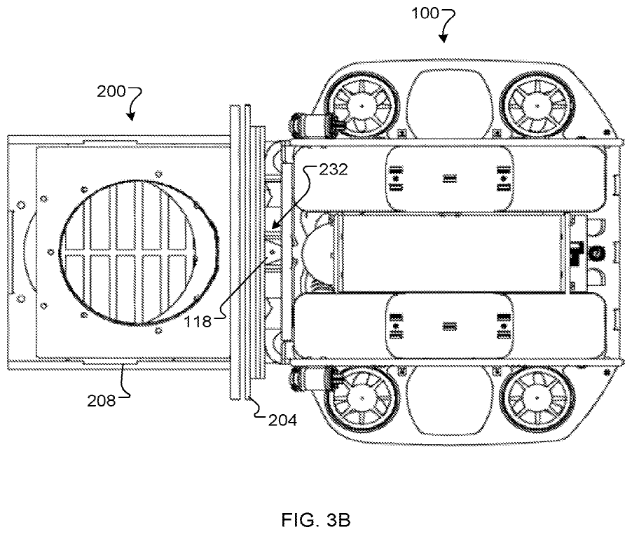

FIGS. 3A and 3B include perspective and top views, respectively, of the vehicle 100 attached to the dock 200. The hook 118 in this instance is secured by the retention latch 232.

In various examples, the dock 200 can be used with a variety of aquaculture cage designs, including traditional surface cages and/or submerged cages. Further, while the depicted embodiment of the dock 200 has a vertical structure or orientation, other embodiments may use a horizontal structure or orientation, in which case components of the dock 200 can be rearranged or reconfigured appropriately. The dock 200 may be constructed out of or include one or more polymeric materials (e.g., High Density Polyethylene (HDPE), polypropylene, polyester, or nylon), metals (e.g., aluminum), and/or other appropriate materials.

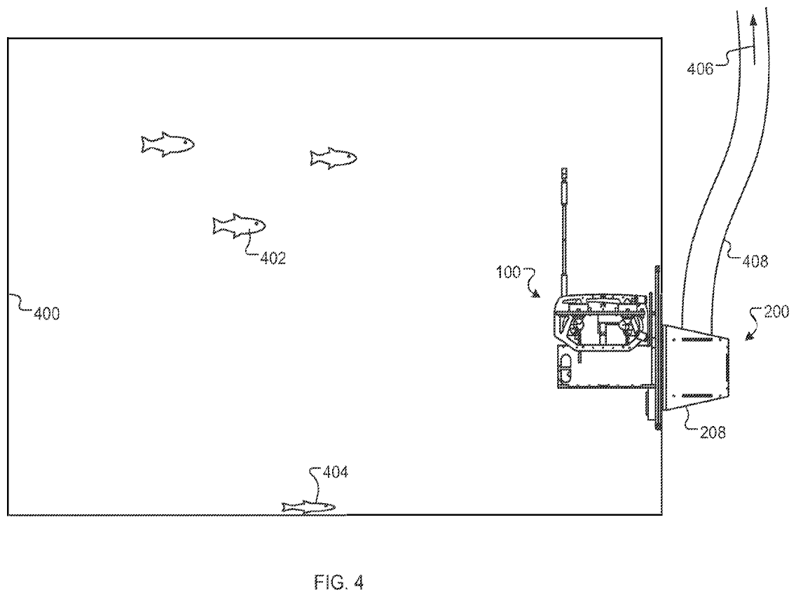

FIG. 4 is a schematic diagram of an example in which the dock 200 is attached to a sidewall of an aquaculture cage 400 containing a plurality of fish 402. The vehicle 100 in this example is attached to the dock 200. The vehicle 100 can be used to collect dead fish 404 or other mortalities, as described herein. Once collected, the vehicle 100 can transfer the mortalities to the storage tank 208 in the dock 200. The mortalities can then be pumped (406) through a conduit 408 (e.g., a tube having a diameter of about 20-25 cm) from the storage tank 208 to a surface barge or vessel (not shown).

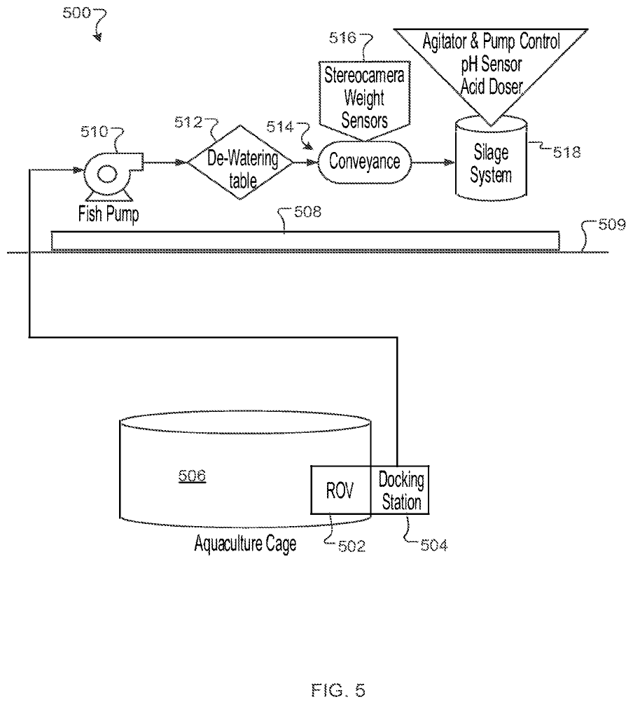

FIG. 5 includes a schematic diagram of an embodiment of a complete mortality removal system 500 in an offshore environment. A collection vehicle 502 (which can be the same as the vehicle 100) can begin a mortality cleaning session from a dock 504 (which can be the same as the dock 200). The vehicle 502 can detach from or leave the dock 504 and travel along a search path within an aquaculture cage 506, such as along a floor of the cage 506. The search path may be deterministic (e.g., fully predetermined) or may be random (e.g., may depend on what the vehicle 502 detects or encounters). The vehicle 502 may use one or more external or internal sensors, such as a beacon (e.g., from the dock 504), a camera, a proximity sensor, a depth sensor, a scanning sonar sensor, a doppler-velocimetry position sensor, and/or machine vision for sensing a wall or other surfaces in the cage 506, detecting mortalities, and/or assisting in adherence to the search path. As the vehicle 502 encounters mortalities along the search path, the vehicle 502 may collect the mortalities (e.g., in the capture enclosure 110). Once the search path has been fully traversed and/or sufficient mortalities have been collected (e.g., the capture enclosure 110 is full), the vehicle 502 can return to the dock 504 where the mortalities can be deposited. The search path can be continually improved and augmented (e.g., using machine learning) to achieve a desired or optimal mortality collection. For example, the system 500 can learn over time where mortalities tend to settle in the cage and can focus collection efforts in those locations.

In the depicted example, the system 500 may utilize or include a moored barge 508 or other vessel floating on a surface 509 of a body of water. Power and communications for the vehicle 502 may come from the barge 508 via a tether (e.g., the tether 108) to the vehicle 502. The dock 504 may be placed at a strategic point in the cage 506, such as a front-bottom of the cage 506. Mortalities can be removed from the dock 504 at periodic intervals (e.g., once per day), after the vehicle 502 has delivered mortalities to the dock 504, or when a sensor signal indicates that a pen (e.g., the storage tank 208) in the dock 504 is full or at a threshold level. To remove the mortalities from the dock 504, a powerful water pump 510 on the barge 508 or other surface support barge platform (or in the dock 504) can move water (e.g., seawater) through a hose connected to the dock 504 (e.g., the conduit 408), without mechanically damaging fish that pass through it. Movement of the water can transfer the mortalities from the pen in the dock 504 and onto a dewatering table 512. The water can be collected or directed off a deck of the barge 508 or surface vessel. Dead fish or other mortalities can be moved from the dewatering table 512 using a porous (e.g., mesh) conveyor belt 514, that allows water to pass through. As the mortalities are conveyed, monocular or stereo pictures of the mortalities may be captured using a camera system 516. Additionally or alternatively, load cells can be used to measure or determine a quantity and/or a weight for each mortality or group of mortalities. Finally, the mortalities can be deposited into a tank within a processing system 518 (e.g., a silage processing system), where the mortalities can be macerated by a grinder, deposited in acids or other materials, and/or refrigerated or frozen, to manage a decomposition process. Various useful byproducts can be derived from the processed mortalities including, for example, feed for livestock, oil for combustion, and/or an additive for anti-fouling coatings. Advantageously, all the steps described above can be performed with little or no human intervention. Process control techniques, computer vision, artificial intelligence, and/or machine learning can be utilized to perform the processing steps in response signals received from sensors in the system 500. In various examples, signals from cameras or other sensors can be transmitted (e.g., via satellite and/or over the Internet) to permit the system 500 to be monitored by one or more human operators in remote locations.

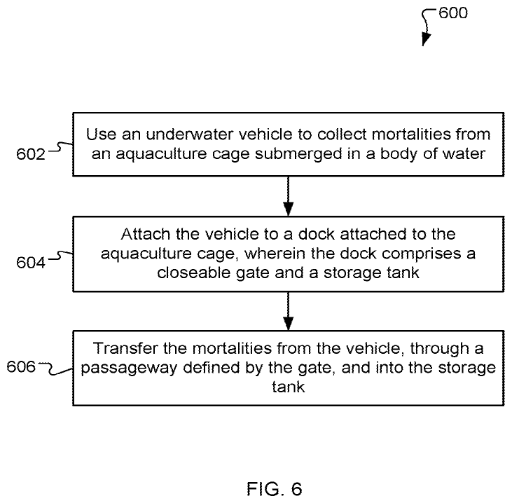

FIG. 6 is a flowchart of an example method 600 of removing mortalities from an aquaculture cage. An underwater vehicle (e.g., vehicle 100) is used (step 602) to collect mortalities from an aquaculture cage submerged in a body of water. The vehicle can include: a plurality of thrusters configured to orient and propel the vehicle in the aquaculture cage; a capture enclosure configured to store the collected mortalities; and a suction device configured to provide suction for transferring the mortalities into the capture enclosure. The vehicle is attached (step 604) to a dock attached to the aquaculture cage. The dock includes a closeable gate and a storage tank. The mortalities are transferred (step 606) from the vehicle, through a passageway defined by the gate, and into the storage tank. The vehicle can open the gate before the mortalities are transferred to the storage tank, and can close the gate once the transfer is complete.

In various examples, the collection vehicles (e.g., vehicle 100) and/or other system components described herein can be monitored or controlled by one or more operators from a remote location. The remote location can be on a surface barge or vessel associated with an aquaculture cage, or the remote location can be onshore, several or many kilometers away from the aquaculture cage. In some instances, for example, communications with the vehicle can be provided using the Internet and/or other network. The surface barge can be connected to the Internet via satellite, and the vehicle can be connected to the barge via a wireless or wired connection (e.g., using the tether 108).

In some instances, for example, a human operator is able to communicate and interact with the vehicle 100 and/or other system components using a network connection, which can include the Internet and/or cloud services. One or more uplinks near the aquaculture cage (e.g., on a surface barge or vessel) can provide network computing and networking equipment connectivity to the Internet (e.g., via satellite). Networking and computing equipment may include firewalls, embedded computers, switches, Internet Protocol (IP) enabled cameras, and other network enabled devices, which can facilitate secure, reliable monitoring, and command and control (C2) of the system components. The computing and networking equipment may communicate directly with the vehicle 100 or other system components through standardized protocols, such as Transmission Control Protocol (TCP), or indirectly through an electromechanical device which supports a protocol like TCP. The operator can utilize a control device from a remote location (e.g., onshore) to operate the vehicle, if desired. The control device can include one or more input components, such as a button or joystick. The operator can operate the vehicle 100 while viewing a live video feed from one or more cameras on the vehicle 100. This can allow the operator to use the vehicle 100 to identify and collect mortalities in the aquaculture cage and deliver the mortalities to the dock.

Additionally or alternatively, in various examples, the vehicle 100 can utilize computer vision, process controls, machine learning, and/or artificial intelligence to operate autonomously, with little or no human intervention. The vehicle 100 can include or be connected to a processor (e.g., residing on the vehicle 100 or on a surface vessel) that receives signals from one or more sensors on the vehicle 100. The signals can be analyzed by the processor, and the processor can execute instructions according to the signals. Based on the signals and the instructions, the vehicle 100 can automatically recognize or identify a mortality within the cage, collect the mortality, and deliver the mortality to the dock.

In certain examples, such automation can be achieved using one or more machine learning models (or other predictive models or artificial intelligence) configured to process data received or derived from sensors on the vehicle 100. The machine learning models can be used for a variety of purposes, including, for example, identifying and recognizing mortalities, distinguishing mortalities from live fish or other objects, and navigating the vehicle 100 during the mortality collection and removal process. Alternatively or additionally, the machine learning models can be updated or refined as needed, for example, by collecting new data that can be used to retrain the models.

In some examples, when identifying mortalities, the vehicle 100 can use a camera or other sensor to collect data related to objects in an aquaculture cage, and the machine learning models can analyze the data to determine if the objects are mortalities. For example, the machine learning model may calculate a score representing a likelihood that an object is a mortality. Objects having a score that exceeds a threshold can be identified as mortalities. Alternatively or additionally, the vehicle 100 or other system components (e.g., cameras and processors) can monitor the cage in an effort to identify mortalities. For example, when a new object appears at the bottom of the cage and the object has not moved for a threshold period of time (e.g., 30 minutes) the vehicle 100 or other system components can determine that the object is a mortality. To identify such stationary objects, image processing can be performed on a sequence of images taken of the aquaculture cage. Once a mortality has been identified, the vehicle 100 can move to the location of the mortality, collect the mortality, and deliver the mortality to the dock, as described herein. Such movements of the vehicle 100 can be automated according to process control algorithms or other instructions provided to the vehicle 100. The dock or other portions of the aquaculture cage can have one or more reference markers (e.g., optical targets 234) or can provide a beacon that the vehicle 100 can use for navigation. The vehicle 100 can utilize computer vision to perform the operations described herein.

In various examples, the machine learning models described herein can be or include a trained classifier or a regression model or equation. For example, a machine learning model can be or include a classifier such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other types of predictive models can be used.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an internetwork (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

One having ordinary skill in the art will readily understand that the invention as discussed above may be practiced with steps in a different order, and/or with hardware elements in configurations which are different than those which are disclosed. Therefore, although the invention has been described based upon these preferred embodiments, modifications, variations, and alternative constructions exist that are within the spirit and scope of the invention.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

What is claimed is:

1. A system for removing mortalities from an aquaculture cage, the system comprising:
an underwater vehicle comprising:
a plurality of thrusters configured to orient and propel the vehicle in an aquaculture cage submerged in a body of water;
a capture enclosure configured to carry a plurality of mortalities collected by the vehicle in the aquaculture cage; and
a suction device configured to provide suction for transferring the mortalities into the capture enclosure; and
a dock attached to the aquaculture cage and comprising:
a closeable gate defining a passageway to receive the mortalities from the vehicle; and
a storage tank for storing the mortalities received from the vehicle.

2. The system of claim 1, wherein the vehicle is configured to perform mortality removal tasks autonomously, and wherein the tasks comprise identifying the mortalities in the aquaculture cage, collecting the mortalities from the aquaculture cage, and transferring the mortalities to the storage tank.

3. The system of claim 1, wherein the vehicle is configured to be controlled by an operator using remote control.

4. The system of claim 1, wherein the thrusters are configured to move the vehicle to any location within the aquaculture cage.

5. The system of claim 1, wherein the capture enclosure is disposed on a bottom portion of the vehicle, and wherein the capture enclosure comprises: an open end for receiving the mortalities; and an opposite end containing the suction device.

6. The system of claim 1, wherein the gate is slidable within the dock from a closed position to an open position.

7. The system of claim 6, wherein the gate comprises a buoyancy element that causes the gate to be in the closed position when the vehicle is not attached to the dock.

8. The system of claim 6, wherein the vehicle is configured to attach to the dock and slide the gate to the open position.

9. The system of claim 6, wherein the vehicle is configured to attach to the dock by connecting a hook on the vehicle to a linkage on the dock.

10. The system of claim 1, further comprising: a vessel floating on the body of water; and a conduit for conveying the mortalities from the storage tank to the vessel.

11. The system of claim 10, further comprising a pumping device for conveying the mortalities from the storage tank to the vessel.

12. The system of claim 10, wherein the vessel comprises: a dewatering table for receiving the mortalities from the storage tank; one or more sensors for measuring weights or quantities of mortalities; and a processing system for storing or processing mortalities received from the dewatering table.

13. A method of removing mortalities from an aquaculture cage, the method comprising:
using an underwater vehicle to collect mortalities from an aquaculture cage submerged in a body of water, wherein the vehicle comprises:
a plurality of thrusters configured to orient and propel the vehicle in the aquaculture cage;
a capture enclosure configured to carry the collected mortalities; and
a suction device configured to provide suction for transferring the mortalities into the capture enclosure;
attaching the vehicle to a dock attached to the aquaculture cage, wherein the dock comprises
a closeable gate and a storage tank; and
transferring the mortalities from the vehicle, through a passageway defined by the gate, and into the storage tank.

14. The method of claim 13, wherein using the vehicle to collect mortalities comprises identifying the mortalities in the aquaculture cage.

15. The method of claim 13, wherein the vehicle is configured to identify and collect the mortalities autonomously.

16. The method of claim 13, wherein attaching the vehicle to the dock comprises connecting a hook on the vehicle to a linkage on the dock.

17. The method of claim 13, wherein transferring the mortalities from the vehicle comprises opening the gate.

18. The method of claim 17, wherein transferring the mortalities from the vehicle further comprises: closing the gate; and detaching the vehicle from the dock.

19. The method of claim 13, further comprising pumping the mortalities from the storage tank to a vessel floating on the body of water.

20. The method of claim 19, further comprising: dewatering the mortalities pumped to the vessel;
measuring weights or quantities of the dewatered mortalities; and storing or processing the dewatered mortalities on the vessel.
